(19) United States
(12) Patent Application Publication
(10) Pub. No.: US 2005/0171935 A1
(43) Pub. Date: Aug. 4, 2005

(54) Methods, systems, and storage mediums for facilitating information storage and retrieval of addressing data

(76) Inventors: Jane Nowak, Marietta, GA (US); Thomas Devanbu, Norcross, GA (US); Leonid Volozhanin, Lilburn, GA (US); Kathy Peterson, Warner Robbins, GA (US); Dovie Reeder, Shelby, AL (US)

Correspondence Address: CANTOR COLBURN LLP, 55 GRIFFIN ROAD SOUTH, BLOOMFIELD, CT, 06002, US

(21) Appl. No.: 10/769,199

(22) Filed: Jan. 30, 2004

(51) Int. Cl. G06F 7/00

(52) U.S. Cl. 707/3

(57) ABSTRACT

Exemplary embodiments of the invention relate to methods, systems, and storage mediums for facilitating information storage and retrieval of addressing data. The method includes parsing addressing data imported from a legacy file, generating searchable records of parsed addressing data, and presenting at least one of the records to a first analyst via a graphical user interface for analysis. The method further includes generating a referral for the record as a result of the analysis via the graphical user interface, assigning a pending status to the referral indicating the referral requires further analysis, and saving the referral in a database. The referral includes the parsed addressing data and a correction type code. The correction type code indicates a recommended action to be performed on addressing data contained in the referral.

### BACKGROUND OF INVENTION

Embodiments of the present invention relate generally to database management and, more particularly, to methods, systems, and storage mediums for facilitating information storage and retrieval of address referrals.

Service industries that utilize business and residential addressing information often find it difficult to maintain up-to-date addressing data. Addressing information is dynamic, elusive, and complex. Businesses close, families move, new housing and business developments are built, real estate properties get re-zoned, and a variety of other factors affect fluctuations in addressing information. Addressing information is captured and housed in large data stores, some of which are proprietary to a business or organization, and others are commercial products that are provided to entities usually for a fee.

Performing services under these continuously evolving conditions can be challenging. For example, a telephone service provider or cable television service provider need to have current and accurate information about its customers in order to provide and maintain a desirable level of service and remain competitive in the marketplace. Updating and maintaining such large quantities of fluctuating data has been generally a manual task and sometimes addressing information is not updated until a problem occurs at which time a physical change to the database of addressing information is then made.

What is needed, therefore, is a way to facilitate information storage and retrieval of address referrals.

### SUMMARY OF INVENTION

The foregoing discussed drawbacks and deficiencies of the prior art are overcome or alleviated by the addressing referral system of the invention

Exemplary embodiments of the invention relate to methods, systems, and storage mediums for facilitating information storage and retrieval of address referrals. The method includes parsing addressing data imported from a legacy file, generating searchable records of parsed addressing data, and presenting at least one of the records to a first analyst via a graphical user interface for analysis. The method further includes generating a referral for the record as a result of the analysis via the graphical user interface, assigning a pending status to the referral indicating the referral requires further analysis, and saving the referral in a database. The referral includes the parsed addressing data and a correction type code. The correction type code indicates a recommended action to be performed on addressing data contained in the referral.

Embodiments of the system include an originating analyst center including a first server. The first server stores at least one legacy file containing addressing data. The system also includes a receiving analyst center that includes a computer client system. The system further includes a host system comprising a second server in communication with the originating analyst center and the receiving analyst center via a communications network. Also included in the system is an addressing referral system and graphical user interface executing on the second server and a data repository in communication with the host system. The data repository stores addressing data imported and parsed from the legacy files by the addressing referral system. The system also includes at least one referral created at the originating analyst center via the graphical user interface. The referral is created in response to analysis performed on parsed addressing data. The referral is stored in the data repository and is accessible to the receiving analyst center. The referral includes addressing data and a correction type code used for recommending an action to be taken for the addressing data by the receiving analyst center.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring to the exemplary drawings wherein like elements are numbered alike in the several FIGURES:

FIG. 1 is a block diagram of a system upon which the addressing referral system is implemented in accordance with exemplary embodiments of the invention;

FIG. 2 is a flowchart describing a process of implementing the addressing referral system in accordance with exemplary embodiments of the invention;

FIG. 3 is a sample computer screen window provided by the addressing referral system for use in enabling an originating analyst to search records for subsequent analysis in accordance with exemplary embodiments of the invention;

FIG. 4 is a sample computer screen window displaying records retrieved by the addressing referral system as a result of a search performed by an originating analyst in accordance with exemplary embodiments of the invention;

FIG. 5 is sample computer screen window provided by the addressing referral system to an originating analyst subsequent to selecting a record to analyze and/or update in accordance with exemplary embodiments of the invention;

FIG. 6 is a sample computer screen subwindow presented by the addressing referral system that enables an originating analyst to filter records retrieved during a record search in accordance with exemplary embodiments of the invention;

FIG. 7 is a sample computer screen subwindow presented by the addressing referral system that enables an originating analyst to select and/or filter columns of data fields resulting from a record search in accordance with exemplary embodiments of the invention;

FIG. 8 is a sample computer screen window presented by the addressing referral system as a result of filtering and selecting columns of data fields relating to records searched by an originating analyst in accordance with exemplary embodiments of the invention;

FIG. 9 is a sample computer screen window presented by the addressing referral system that enables an originating analyst to search for records and referrals using a variety of search criteria in accordance with exemplary embodiments of the invention;

FIG. 10 is a sample computer screen window presented by the addressing referral system as a result of performing a search for referrals by an originating analyst in accordance with exemplary embodiments of the invention;

FIG. 11 is a sample computer screen window provided by the addressing referral system for enabling a performing a search by a receiving analyst in accordance with exemplary embodiments of the invention;

FIG. 12 is a sample computer screen window provided by the addressing referral system including a menu of selectable reporting options in accordance with exemplary embodiments of the invention; and

FIG. 13 is a sample history report created by the addressing referral system in accordance with exemplary embodiments of the invention.

### DETAILED DESCRIPTION

Disclosed herein is a method, system, and storage medium for facilitating information storage and retrieval of addressing data. The addressing referral system provides a means for gathering addressing data from a data store (e.g., legacy system), parsing the data, and inputting the data to a GUI for analysis. Depending upon the results of the analysis, referrals may be generated in order to provide further evaluation, pursue corrective action including follow up measures, and updating the results to a database. The addressing referral system tracks the progress of the referrals throughout the process. A variety of reporting options are available through the addressing referral system as well. Reporting options may be used to check statuses of work items, balance workloads, monitor employee productivity, and manage the overall referral process.

While the addressing referral system is described herein with respect to the telephone service industry, it will be understood by those skilled in the art that the addressing referral system may be implemented by any entity that utilizes addressing information such as, but not limited to, the cable television service industry, utility industries, and government entities such as a registry of motor vehicles or police and fire departments, to name a few.

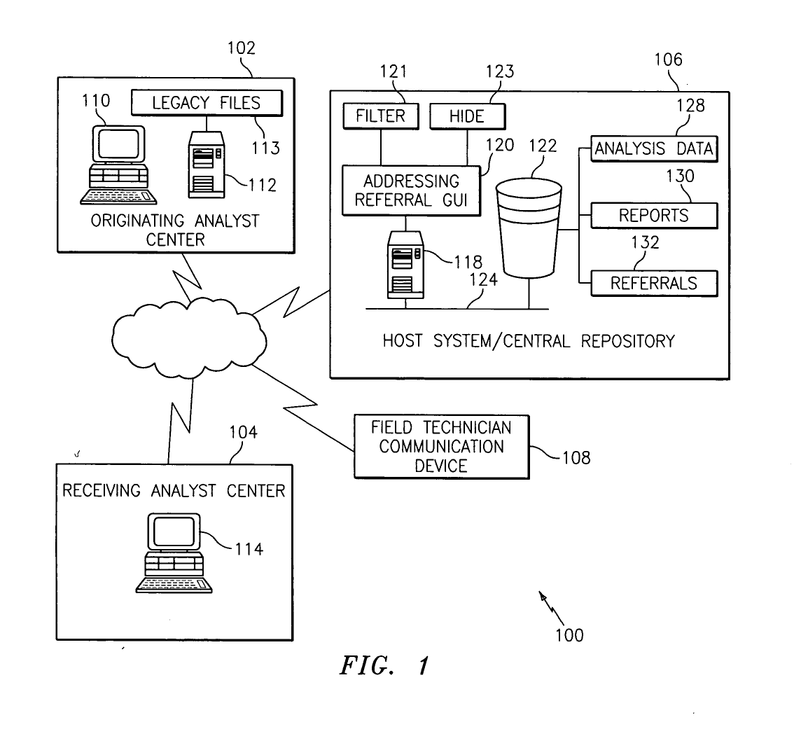

Referring initially to FIG. 1, there is shown a block diagram of a network system for implementing the addressing referral system in exemplary embodiments of the invention. Network system 100 includes an originating analyst center 102, a receiving analyst center 104, and a remote communications device 108, each of which is in communication with a host system 106 via a communications network. The communications network may include any type of network such as a public switched telephone network (PSTN), wireless, WiFi, LAN, WAN, IP, radio, VoIP, etc., or a combination of the above.

Originating analyst center 102 includes a computer client system 110 and a server 112. An analyst on computer client system 110 exports legacy files 113 that comprise addressing data to server 112 in response to queries to the legacy system for legacy reports. Originating analyst center 102 represents an analysis center designed to manage and improve database information. For example, originating analyst center 102 may provide engineering services, dispatch, and similar services for entities that utilize addressing information such as receiving analyst center 104. Server 112 may comprise a high-powered multiprocessor computer device or may be a server including web and applications server software for receiving requests from computer client system 110 to process addressing information and exchange data between each other via the Internet or other network.

Receiving analyst center 104 includes a computer client system 114. An analyst on computer client system 114 accesses referrals via GUI 120 that have been generated by originating analyst center 102 and performs evaluation and possible corrective actions on the referrals. Originating analyst center 102 serves as a ‘watchdog’ for receiving analyst center 104. Receiving analyst center 104 represents an assignment center.

Remote communications device 108 represents a communications device used by a field technician associated with the servicing entity that communicates with centers 102, 104, and/or 106 when performing fieldwork such as installations or repairs. Remote communications device 108 may comprise a wireless telephone, a personal digital assistant, a two-way radio, a personal computer installed in a technician's vehicle or otherwise provided to the remote technician, among other suitable mobile communications tools.

While network system 100 features only one originating analyst center 102, one receiving analyst center 104, and one remote communications device 108, it will be understood that any number of centers/remote devices may be utilized to realize the advantages of the invention.

Computer client systems 110 and 114 may be general-purpose desktop computers that subscribe to an Internet service and may each include an email application, a web browser application, and/or any other suitable programs that reside in memory and execute on computer client systems 110 and 114. It will be understood by those skilled in the art that the addressing referral system of the invention may be executed on systems with variant architectures. Computer client systems 110 and 114 are in communication with other entities of network system 100 via a network connection such as the Internet or other suitable means of networking architecture.

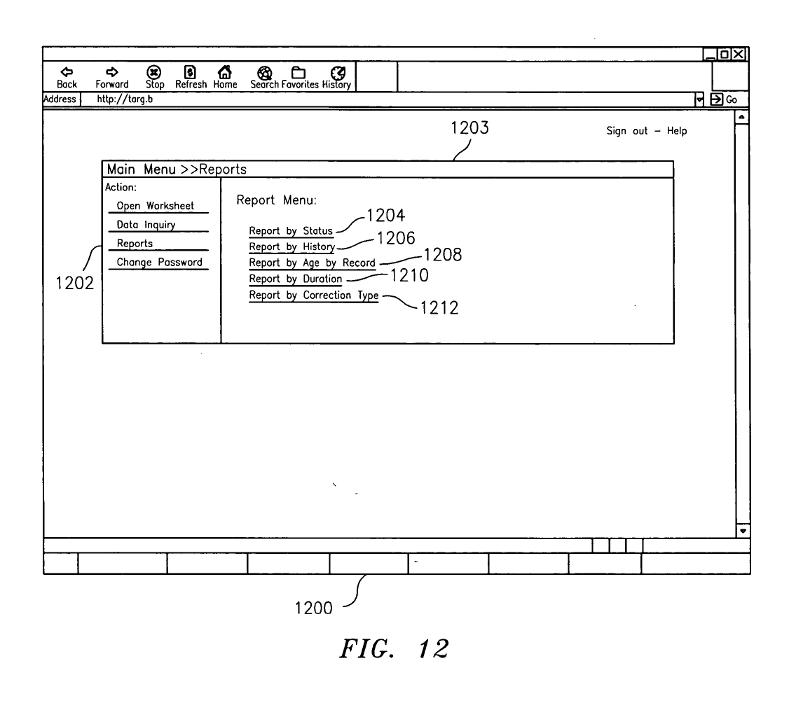

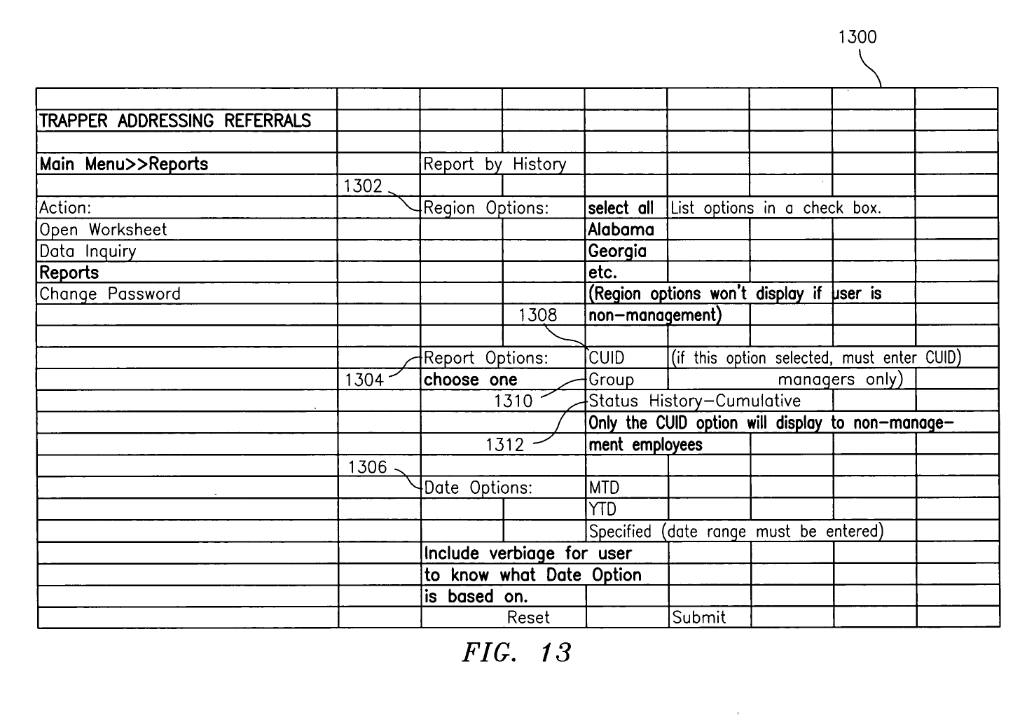

Host system 106 includes a server 118 and data repository 122 in communication via a network 124. Data repository 122 stores analysis data database 128, reports database 130, and referrals database 132. Analysis data database 128 refers to records of addressing data that have been parsed by the addressing referral system, assigned an initial status of “open”, and are selectable by an originating analyst center for analysis. A record may include such information as house number/unit number, street name, city, district, etc. for a specific location. Reports database 130 stores a variety of addressing reports created via the addressing referral system. Reporting options are described further in FIGS. 12 and 13. Referrals database 132 stores referrals that have been created by an originating analyst for purposes of identifying possible corrective actions to be taken for the address cited in the referral or for further evaluation by a receiving analyst. Referrals include address data, correction codes, and other information used by analysts and the addressing referral system. Three separate databases 128-132 are shown in FIG. 1 for illustrative purposes. However, it will be understood by those skilled in the art that any number of databases may be utilized to house the data described with respect to databases 128-132, including a single database of tables, in order to realize the advantages of the invention. Thus, the recitation of three separate databases is not meant to be construed as limiting in scope.

Network 124 may comprise a wireline cable directly linking server 118 to data repository 122 or may comprise a network system such as an Intranet. In one embodiment, server 118 executes the addressing referral system and allows analyst centers 102 and 104 to access its features and functions as described further herein.

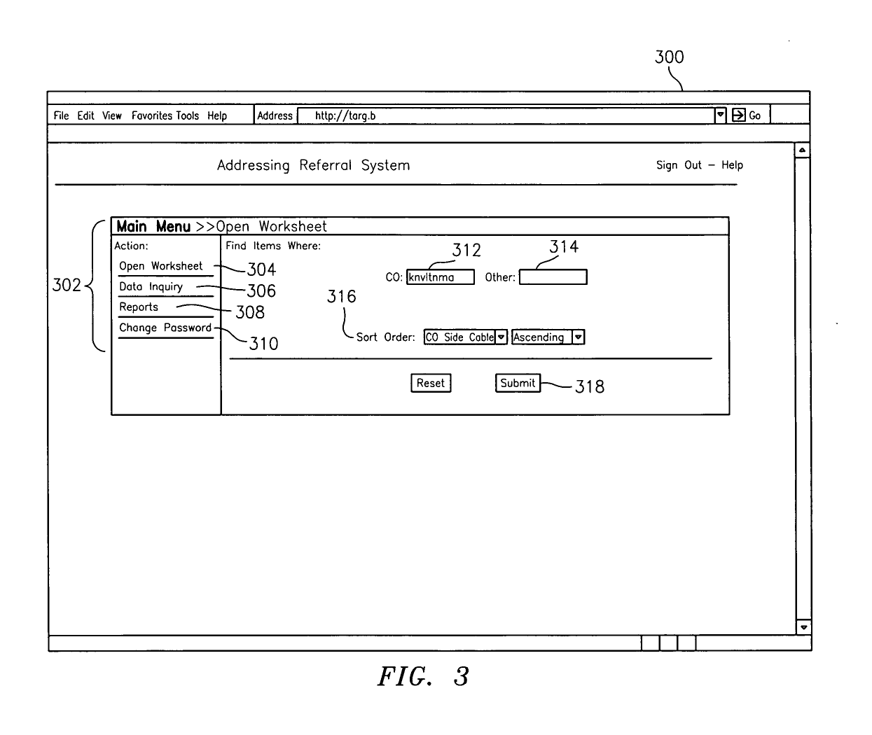

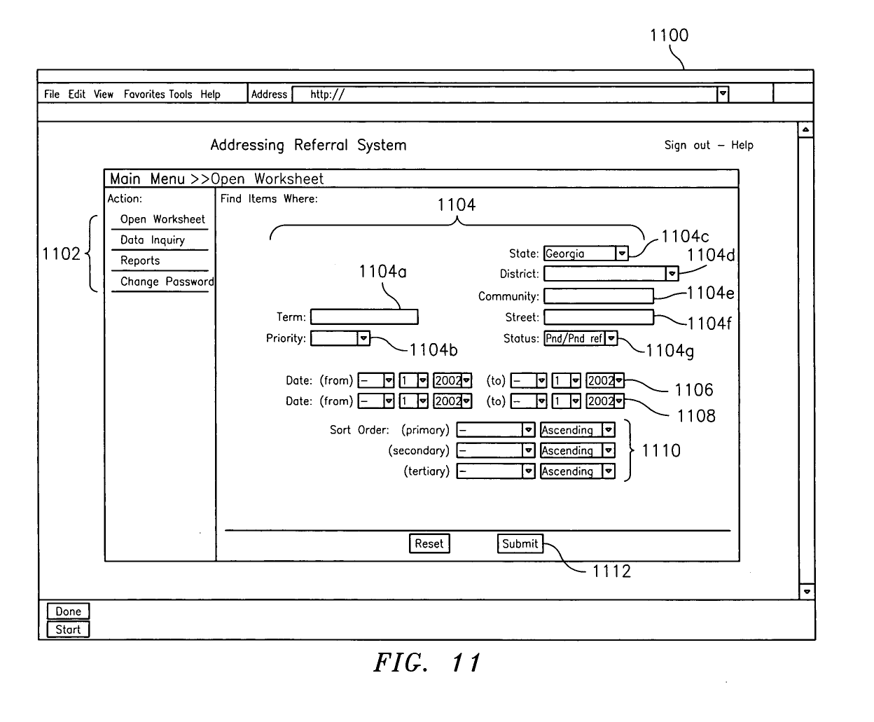

The addressing referral system includes a graphical user interface 120. A main menu 302 of addressing referral system graphical user interface 120 (as shown in FIG. 3) includes four options: open worksheet 304, data inquiry 306, reports 308, and change password 310. These four options 304-310, as described herein, are functionally similar to options 1102 shown in FIG. 11. Options 304-310 are distinguishable from options 1102 in that the type of information accessible via these functions are dependent upon whether an originating analyst is requesting information or a receiving analyst is requesting information. For example, the computer screen of FIG. 3 corresponds to what an originating analyst sees upon accessing worksheet option 304, while FIG. 11 illustrates a computer screen viewed by a receiving analyst upon selecting the open worksheet option 1102. The open worksheet option 304 allows an analyst to access referrals entered by originating analyst center 102 in order to perform investigation and update activities. Data inquiry option 306 allows an analyst to view (but not edit) referrals entered by originating analyst center 102. Reports option 308 allows an analyst to request reports generated by the addressing referral system. Change password option 310 enables an analyst to change individual passwords for accessing the system. The sample computer screens of FIGS. 3-13 illustrate some of the features of the addressing referral system graphical user interface 120 and are described further herein. GUI 120 also provides navigational tools including a filter tool 121 and a ‘hide’ tool 123, both of which are described further herein.

In alternative embodiments, analyst centers 102 and 104 execute the addressing referral system. In yet a further embodiment, analyst centers 102 and 104 share execution of the addressing referral system with host system 106 and may store the addressing referral system software internally. Further, in alternative embodiments, data manipulated by the addressing referral system may be stored at one or both of analyst centers 102 and 104, in addition to, or in lieu of data repository 122. Host system 106 may be a corporate entity of analyst centers 102 and 104 that provides a centralized repository of addressing referral information, or host system 106 may be an applications service provider that provides web services such as the addressing referral system, and/or content management services on behalf of analyst centers 102 and 104. It will be understood that other embodiments, in addition to those specified above, are contemplated by the addressing referral system and that the above representations are made for illustrative purposes and should not be construed as limiting in scope.

As indicated above, the addressing referral system may be executed as a standalone application that is installed or downloaded on a computer client system or may be incorporated into an existing application or similar commercially available product as an enhancement feature. Further, as indicated above, the features of the addressing referral system may be provided via a third party application service provider (ASP) or e-utilities broker where service is provided for a per-use fee in alternative embodiments.

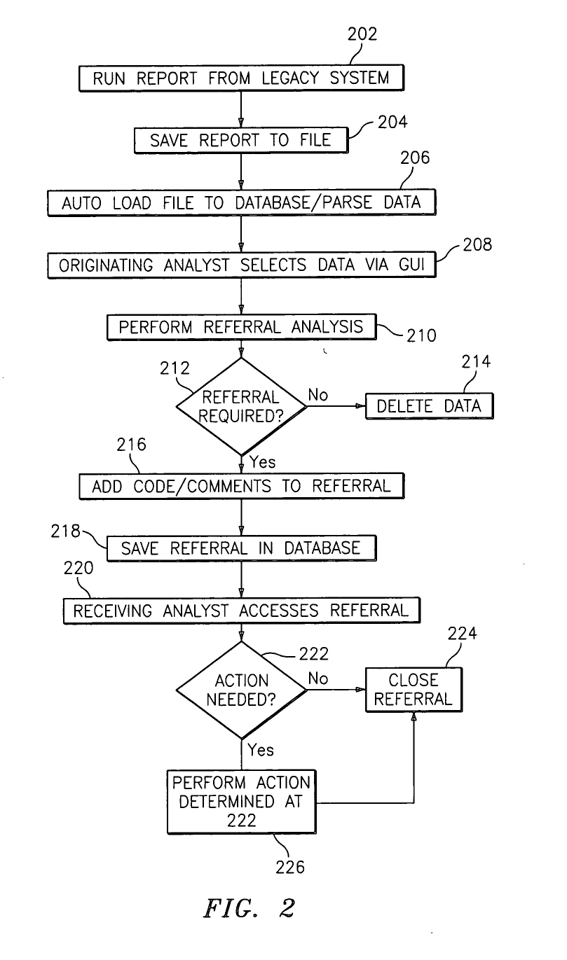

FIG. 2 is a flowchart describing the process of implementing the addressing referral system. A user at originating analyst center 102 runs a report from a legacy system at step 202 and saves the report to a file 113 on server 112 at step 204. Server 118 periodically accesses server 112, imports files 113, parses data from files 113, and stores the records of parsed data in analysis data database 128 in data repository 122 at step 206. The addressing referral system assigns an initial status of “open” to each record indicating that the record is awaiting analysis by an originating analyst.

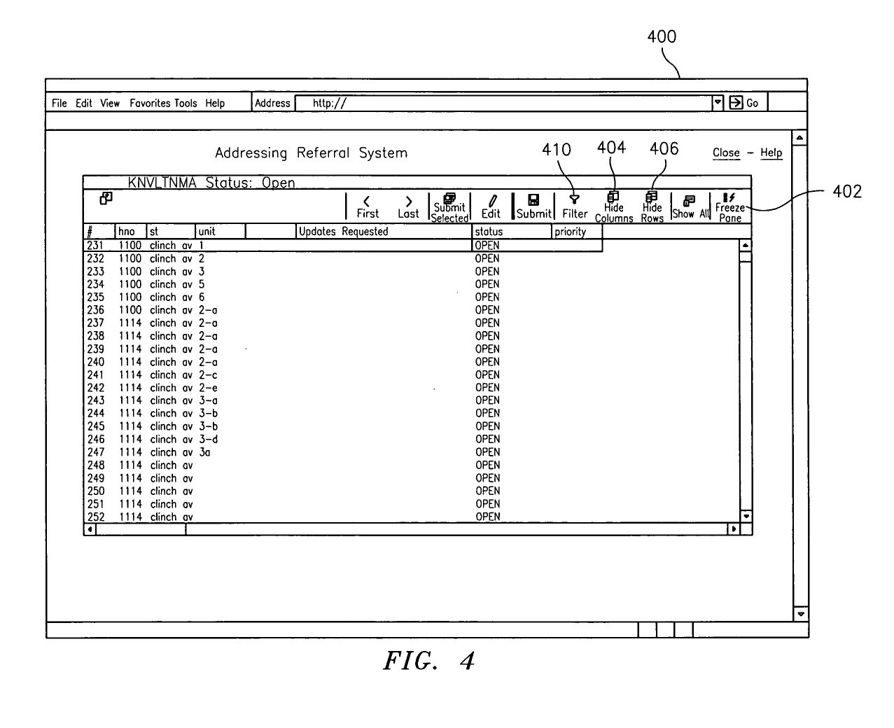

An analyst at originating analyst center 102 accesses GUI 120, searches for records to analyze at step 208, and performs an initial analysis at step 210. This may be accomplished via computer screens 300 and 400 of FIGS. 3 and 4, respectively. Specifically, an originating analyst selects open worksheet option 302 from the computer screen window 300 of FIG. 3 and enters information in one of data fields 312 or 314 which specifies the location of the addressing information desired. The originating analyst may also sort the search results using data field 316 according to sort criteria as shown in FIG. 3. Once completed, the originating analyst clicks on the submit option 318 whereby the addressing referral system searches for records that meet the criteria selected by the originating analyst. FIG. 4 illustrates a sample computer screen window 400 depicting the results of the search conducted via computer screen window 300. The addressing referral system initially assigns a status of ‘open’ to each record of information indicating that the record is ready for evaluation by an originating analyst.

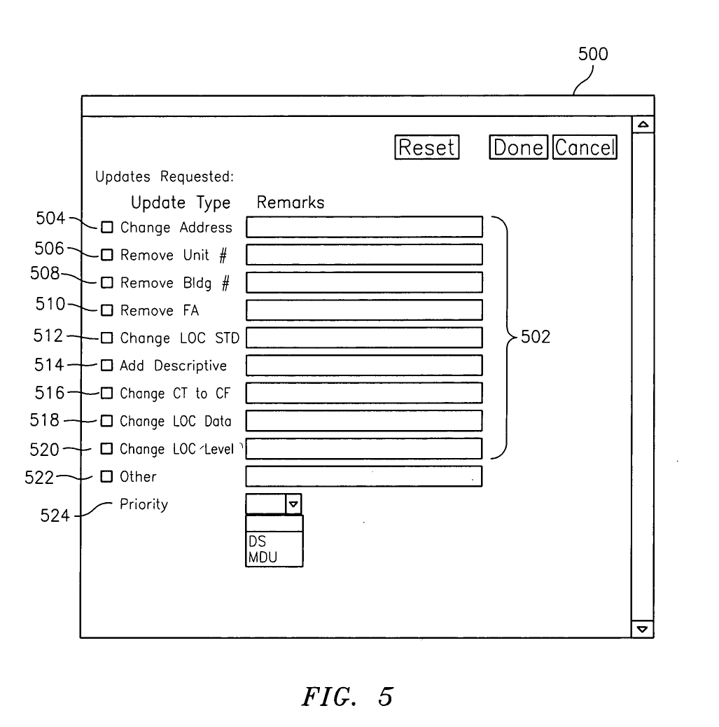

Once a record has been evaluated, the analyst at center 102 determines what records, if any, need to be referred to receiving analyst center 104 for further analysis or corrective action at step 212. The evaluation process may involve a number of sources of information relating to addressing data such as government or census data, town directories/maps, etc. Any data that does not require referral may be deleted via GUI 120 at step 214. For records that require referral, the analyst generates a referral by selecting a record via computer screen 400 and selecting the Edit option at the top of the screen, resulting in a subwindow 500 that allows the analyst to provide relevant information about the nature of the referral. This is accomplished utilizing the updates requested option fields 502 as shown in FIG. 5. The analyst selects one or more of correction codes 504-524 in accordance with the type of action the analyst has determined may be required for the record and may include comments if desired at step 216. Correction codes 504-522 allow an analyst to differentiate the various reasons for referral, actions to be taken, or other specific criteria. Correction type codes may include: change address 504, remove unit number 506, remove building number 508, remove facility address (FA) 510, change location standard 512 (LOC std; e.g., apartment numbers identified for a complex will be changed from a lettering system to a numbering system), add descriptive 514 (e.g., how an address may be identified in a database), change status of a cable pair from connect through to connected facility 516 (CT to CF), change location data (LOC data) 518, change local level (LOC level), Other 520 (for providing a customized request), and priority field 524 which allows an analyst to assign a priority to the referral. Priority levels may include dispatch save (DS) that is used when a service order has been recently corrected for this address which, if addressed immediately by the instant dispatch (e.g., by a field technician at an address location using communications device 108), may save the field technician from making a second trip to the location. Priority levels may further include a multi-dwelling unit (MDU) indicator that suggests to the analysis center that an issue in need of addressing for a particular referral may apply to other units at the same location. The newly generated referrals are saved in referral database 132 at step 218.

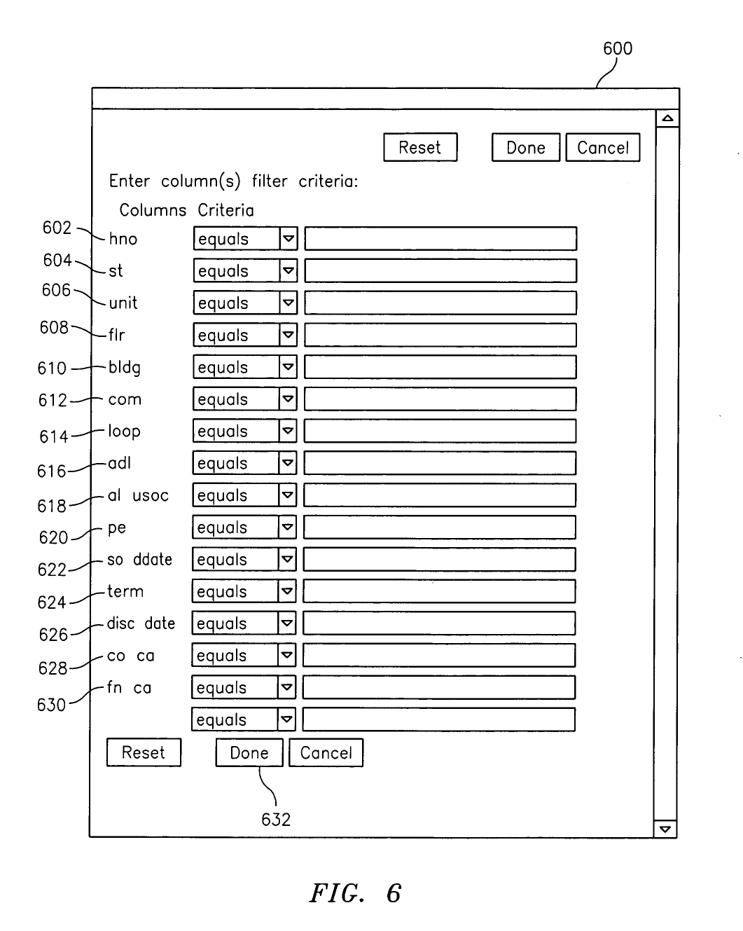

An originating analyst may search for open records and/or referrals to analyze using a variety of navigational aids provided by the addressing referral system GUI 120 as shown generally in FIGS. 6-10. Searching records by using targeted criteria enables the originating analyst to quickly screen for records/referrals that meet specific or general criteria, resulting in greater efficiency. Addressing data for most geographic regions tends to be quite voluminous. The navigational aids of the addressing referral system provide the ability to target very specific information from analysis data database 128 as well as view high level addressing information as needed. One such tool is the filtering tool 121 of the addressing referral system. Filtering tool 121 is selected by clicking on filter icon 410 on the navigational toolbar 402 of one of FIGS. 4, 8, and 10. The filter screen 600 of FIG. 6 is presented to the analyst. The originating analyst selects a criteria preference via a drop down box associated with one or more data fields 602-630. For example, by selecting the drop down box for ‘hno’ 602, the analyst is presented with pre-defined options including ‘equals’, ‘less than’, and ‘greater than’. If the analyst is searching for house number 70 for a particular street, the analyst would select ‘equals’ and enter the number 70 in the corresponding box adjacent to the field. The analyst would further select the criteria drop down box for ‘st’ 604, select ‘equals’ and then enter the street name in the adjacent box. Likewise, the analyst may search for all houses on a given street, all streets in a given community, etc. Other fields of search/filter include unit (e.g., apartment number) 606, floor (fir) 608, building (bldg) 610, community (com) 612, phone number (loop) 614, additional line (adl) 616, class of service such as business or residential (al usoc) 618, pe 620, service order due date (so ddate) 622, disconnect date (disc date) 626, facility cable (co ca) 628, and other cable (fin ca) 630. Once completed, the originating analyst selects ‘done’ 632 and the addressing referral system searches for only those records/referrals that meet the criteria selected, presenting the records/referrals to the analyst for action.

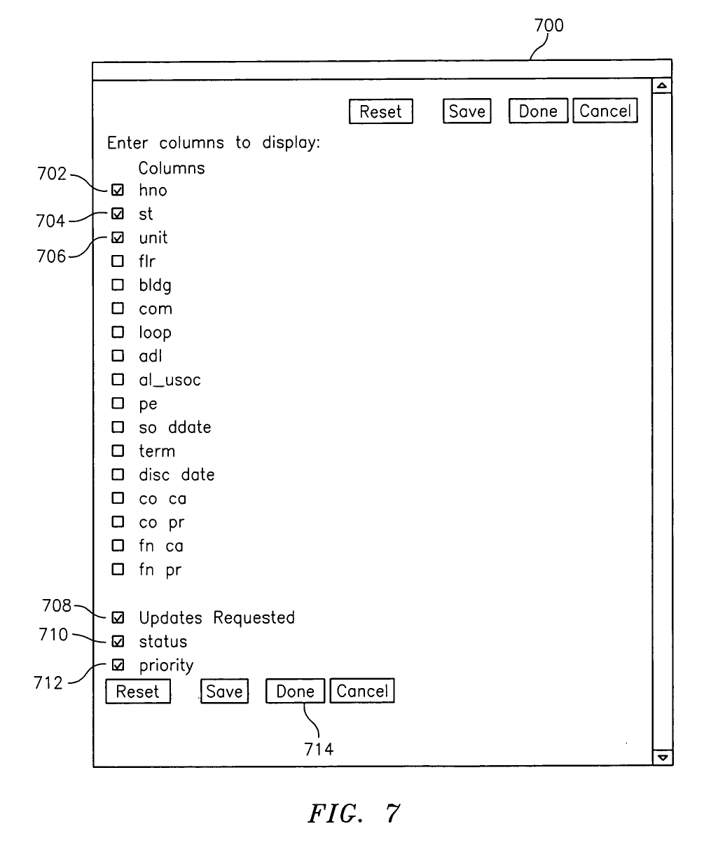

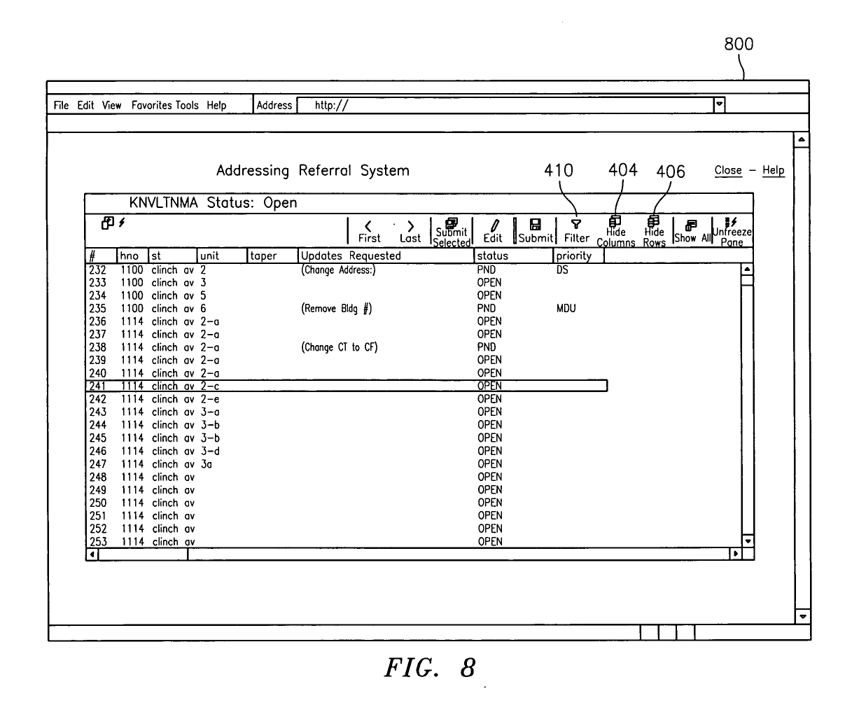

Another navigational aid provided by the addressing referral system is a ‘hide’ feature 123 whereby an analyst selects rows and columns of records/referrals to display. This may be useful where the analyst desires limited information about an address or group of addresses and does not require all of the available information that is associated with the address(es). This feature 123 is initiated by selecting the hide columns icon 404 and/or hide rows icon 406 as shown in FIGS. 4, 8, and 10. FIG. 7 depicts a sample computer screen window 700 that is presented when the analyst selects hide columns icon 404. In the computer screen 700 of FIG. 7 the analyst has selected hno 702, st 704, unit 706, updates requested 708, status 710, and priority 712. The analyst selects ‘done’ 714. The addressing referral system presents the records/referrals selected by the analyst with only those selected columns of information displayed. The computer screen window 800 of FIG. 8 displays the results of these selections.

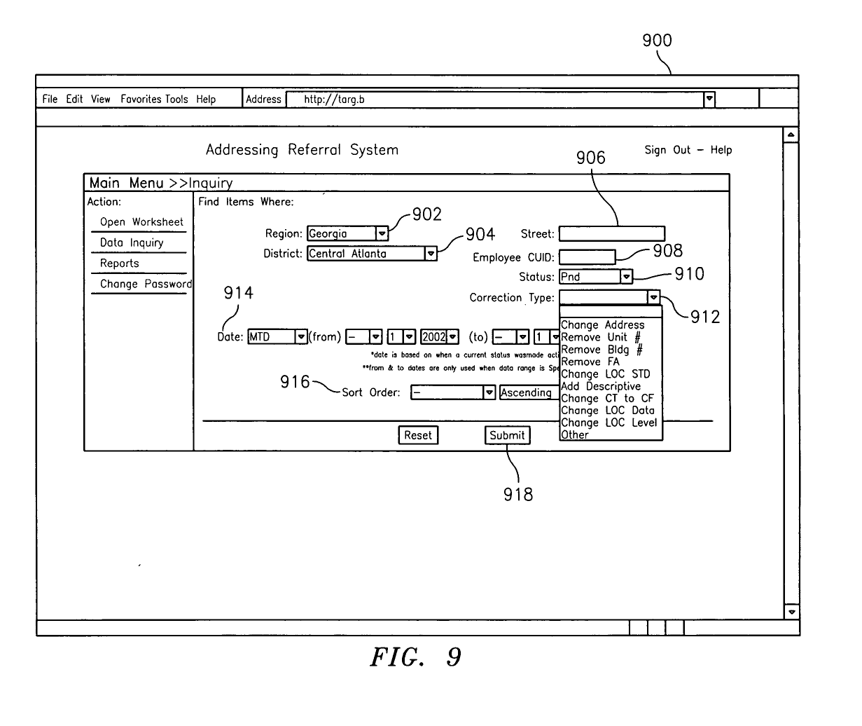

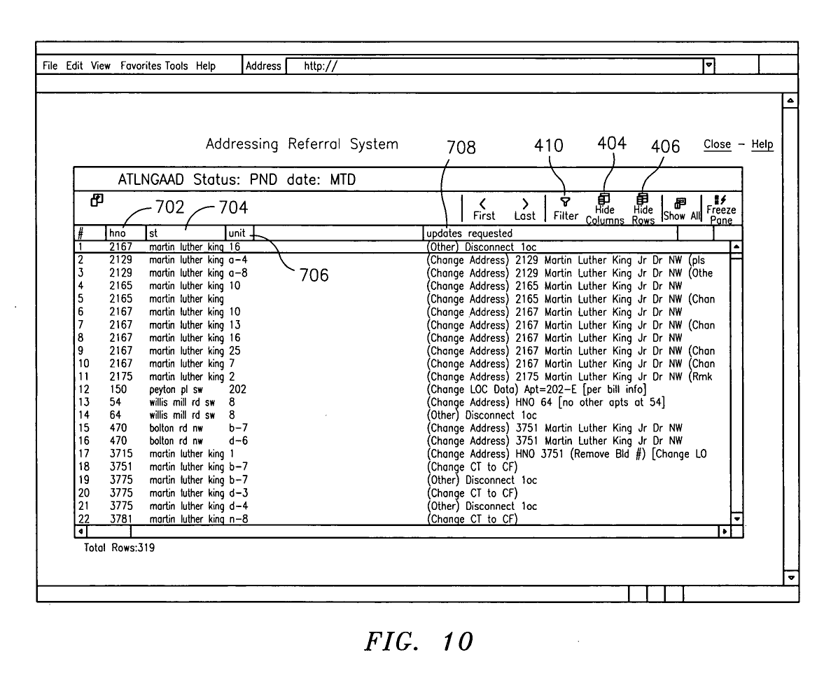

The addressing referral system further enables an originating analyst to track the status of their referrals, perform follow up investigations if necessary, and evaluate the effectiveness and efficiency of the analyses and work performed. This may be accomplished via the sample search screen 900 of FIG. 9. An originating analyst may search records/referrals by location (e.g., fields 902-906), by analyst ID 908, by status 910, by correction code type 912, and by date range 914. The search feature also enables an originating analyst to sort the search results via sort order field 916. Screen 900 illustrates sample entries provided by an originating analyst. Once completed, the originating analyst selects ‘submit’ 918. A partial summary of this search is provided in FIG. 10.

Once the referral has been entered and submitted, it is ready for access and evaluation by a receiving analyst center 104. A receiving analyst accesses a referral via GUI 120 at step 220 and evaluates the data and the associated codes. This step is accomplished by selecting the ‘open worksheet’ option on menu 1102 via computer screen window 1100 of FIG. 11. The open worksheet option allows receiving analyst center 104 to perform editing of referrals provided by originating analyst center 102. The receiving analyst enters data in one or more of fields 1104-1110 as desired and selects ‘submit’ 1112. The addressing referral system searches for referrals that meet the criteria selected in FIG. 11 and presents the referrals to the receiving analyst. The receiving analyst reviews each referral on an individual basis sometimes working on groups of referrals with common data, such as same street name and house number. As the receiving analyst works through each referral, if no further action is required at step 222, the referral is closed by the receiving analyst using a status code (i.e., status field 1104g) provided for that purpose at step 224. If work is needed, the receiving analyst takes the appropriate action and updates the status of each referral as it is handled at step 226, and the referral is closed at 224.

As described above, various searching and reporting options are provided by the addressing referral system. As shown in FIG. 11, when a user selects either the open worksheet or data inquiry option, data fields 1104-1110 are presented to the user for performing various tasks. Analysts may pull up referrals for edit purposes or to view referrals. Data fields 1104a-g provide criteria by which searches may be performed. Termination point 1104a refers to equipment serviced at an addressing location. Priority 1104b allows an analyst to specify a priority level for a referral (e.g., how quickly the action needs to be performed). State 1104c, District 1104d, Community 1104e, and Street 1104f enable an analyst to search for referrals by location criteria. Status 1104g specifies the current status of a referral. Status codes include ‘OPEN’ for records created but not yet evaluated by the originating analyst; ‘PND’ for those referrals that are pending investigation and resolution by analyst center 104; ‘PND REF’ (pending/referred) for identifying those referrals that have been investigated by receiving analyst center 104 and which are waiting on information from another source before the action specified in the referral may be addressed or resolved; ‘CLSD NC’ (closed/no change) for identifying those referrals that have been investigated by receiving analyst center 104 and are determined not to require the execution of the action that was recommended in the referral; and ‘CLSD’ (closed) for specifying referrals for which investigations were made and for which corrective actions were successfully taken.

Referrals may also be searched by date range using fields 1106 and 1108 of FIG. 11. Date range field 1106 enables an analyst to search for referrals that fall within a user-defined date range for originating analyst center 102. Date range field 1108 enables an analyst to search for referrals that fall within a user-defined date range for receiving analyst center 104. For example, an analyst wishes to view/edit referrals from the state of Georgia that have been investigated by a receiving analyst center but remain pending between Mar. 1, 2002 and Apr. 30, 2002. The analyst selects ‘Georgia’ from the drop down option of field 1104c, followed by selecting ‘PND REF’ from the drop down box of field 1104g. The analyst then enters the desired dates in one of date range fields 1108.

When a receiving analyst selects a search option and does not want to use a default sort provided by the addressing referral system, he/she may select a first, second, and third sort 1110. For example, a first sort may be by community option 1104 whereby referrals are sorted by community in alphabetical order. The receiving analyst may specify the sort order as ascending or descending and may select sort options and sort order even when he/she does not define the search criteria 1104 but is using the default display.

The resulting display may contain referrals associated with the login analyst center, or may include referrals for any location serviced by the addressing referral system with proper permissions. If the analyst at receiving analyst center 104 does not want to specify sort or search options, he/she may click on the “submit” button 1112 and the referrals are presented to the analyst as described earlier.

FIG. 12 illustrates a sample screen display 1200 that provides various reporting options that are available to an analyst. When a user selects ‘reports’ from the menu options 1202, a second menu 1200 is displayed as shown in FIG. 12. The user may select from one of five report types 1204-1212. Report by Status 1204 allows an analyst to view the number of referrals that are currently open, pending, pending/referred, closed, and closed/no change as indicated above with respect to status field 1204g.

Report by History 1206 provides information on the efficiency level of a particular analyst. For example, a history report for an individual analyst for a month's period would indicate the number of referrals open, open but deleted (e.g., the number of referrals the employee loaded into the addressing referral system), pending (e.g., the number of referrals the employee decided that an addressing change should be evaluated), pending/referred, closed, closed/no change, percentage of referrals closed, number of correction types (e.g., what problem was addressed), and percentage of referrals still pending. A sample history report menu screen 1300 is shown in FIG. 13. An analyst may search by criteria including region 1302; report options 1304 that comprise employee ID (e.g., CUID) 1308, by group 1310, and by status 1312; as well as by date options 1306.

Report by Age by Record 1208 allows a user to search for specific information. This report can be searched by state and report option criteria. Report by Age by Record 1208 allows a user to view the age of referrals by status category (e.g., open, pending, pending/referred), providing insight into the amount of time a referral has been subject to a particular status.

Report by Duration 1210 allows a user to view referrals and their duration of time between statuses, such as from open to closed, pending to closed, closed to closed/no change. The duration periods range from ‘less than 11 days’, ‘11-20 days’, ‘21-30 days’, and ‘over 30 days.’

Report by Correction Type 1212 allows a user to view referrals according to correction type codes. These referrals can be sorted by state. They may also be sorted by date range.

As will be appreciated from the above description, the restrictions and limitations that exist with traditional manual methods of managing addressing information are efficiently overcome. The addressing referral system includes a graphical user interface for presenting addressing referral information to system users for analysis and updating. The addressing referral system tracks the progress of the referrals throughout the process provides a variety of reporting options as well.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for facilitating information storage and retrieval of addressing data., comprising:
parsing addressing data imported from a legacy file;
generating searchable records of parsed addressing data;
presenting at least one of said records to a first analyst via a graphical user interface for analysis;
generating a referral for said at least one of said records as a result of said analysis via said graphical user interface, said referral including said parsed addressing data and a correction type code;
assigning a pending status to said referral, said pending status indicating said referral requires further analysis; and
saving said referral in a database;
wherein said correction type code indicates a recommended action to be performed on addressing data contained in said referral.

2. The method of claim 1, further comprising:
presenting said referral to a second analyst for evaluation via said graphical user interface;
assigning a new status to said referral by said second analyst in response to said evaluation or performance of a corrective action, said new status comprising at least one of:
pending/referred, indicating that corrective action cannot be performed on addressing data in said referral until additional information is obtained;
closed, indicating that corrective action has been successfully performed on addressing data in said referral; and
closed/no action, indicating that no action is required for addressing data in said referral; and
updating said database indicating said new status.

3. The method of claim 1, wherein said searchable records of parsed addressing data include at least one of:
a house number;
a unit number;
a floor number;
a building identifier;
a phone number;
a street name;
a community;
a district;
a state; and
an equipment identifier.

4. The method of claim 1, wherein said generating a referral further comprises:
assigning a priority to said referral, said priority operable for indicating an urgency for which performance of said action should be undertaken.

5. The method of claim 4, wherein said priority includes at least one of:
a multi-dwelling unit indicator which, if present on said referral, indicates to said second analyst that an address subject to said referral is associated with a group of related addresses and that said related addresses should be evaluated simultaneously with said address subject to said referral; and
a dispatch status indicator which, if present on said referral, indicates to said second analyst that a service order was recently corrected for an address subject to said referral and that said second analyst should address issues presented in said referral as high priority.

6. The method of claim 1, further comprising deleting said records of parsed addressing data in response to said analysis by said first analyst where it is determined that no referral is required, said deleting performed automatically via said graphical user interface.

7. The method of claim 2, further comprising:
generating a report utilizing criteria selectable via said graphical user interface, said report comprising at least one of:
a status report;
a history report;
an age by record report;
a report by duration; and
report by correction type.

8. The method of claim 1, wherein said correction type code includes at least one of:
change address;
remove unit number;
remove building number;
remove facilities address;
change location standard;
add descriptive; and
change location data.

9. The method of claim 1, wherein said generating a referral for said at least one of said records further includes assigning an open status to said records indicating that said records are ready for analysis by said first analyst.

10. A storage medium encoded with machine readable computer program code for facilitating information storage and retrieval of addressing data, the storage medium including instructions for causing a server to implement a method, comprising:
parsing addressing data imported from a legacy file;
generating searchable records of parsed addressing data;
presenting at least one of said records to a first analyst via a graphical user interface for analysis;
generating a referral for said at least one of said records as a result of said analysis via said graphical user interface, said referral including said parsed addressing data and a correction type code;
assigning a pending status to said referral, said pending status indicating said referral requires further analysis; and
saving said referral in a database;
wherein said correction type code indicates a recommended action to be performed on addressing data contained in said referral.

11. The storage medium of claim 10, further comprising instructions for causing said server to implement:
presenting said referral to a second analyst for evaluation via said graphical user interface;
assigning a new status to said referral by said second analyst in response to said evaluation or performance of a corrective action, said new status comprising at least one of:
pending/referred, indicating that corrective action cannot be performed on addressing data in said referral until additional information is obtained;
closed, indicating that corrective action has been successfully performed on addressing data in said referral; and
closed/no action, indicating that no action is required for addressing data in said referral; and
updating said database indicating said new status.

12. The storage medium of claim 10, wherein said searchable records of parsed addressing data include at least one of:
a house number;
a unit number;
a floor number;
a building identifier;
a phone number;
a street name;
a community;
a district;
a state; and
an equipment identifier.

13. The storage medium of claim 10, wherein said generating a referral further comprises:
assigning a priority to said referral, said priority operable for indicating an urgency for which performance of said action should be undertaken.

14. The storage medium of claim 13, wherein said priority includes at least one of:
a multi-dwelling unit indicator which, if present on said referral, indicates to said second analyst that an address subject to said referral is associated with a group of related addresses and that said related addresses should be evaluated simultaneously with said address subject to said referral; and
a dispatch status indicator which, if present on said referral, indicates to said second analyst that a service order was recently corrected for an address subject to said referral and that said second analyst should address issues presented in said referral as high priority.

15. The storage medium of claim 10, further comprising instructions for causing said server to implement:
deleting said records of parsed addressing data in response to said analysis by said
first analyst where it is determined that no referral is required, said deleting performed automatically via said graphical user interface.

16. The storage medium of claim 11, further comprising instructions for causing said server to implement:
generating a report utilizing criteria selectable via said graphical user interface, said report comprising at least one of:
a status report;
a history report;
an age by record report;
a report by duration; and
a report by correction type.

17. The storage medium of claim 10, wherein said correction type code includes at least one of:
change address;
remove unit number;
remove building number;
remove facilities address;
change location standard;
add descriptive; and
change location data.

18. The storage medium of claim 10, wherein said generating a referral for said at least one of said records further includes assigning an open status to said records indicating that said records are ready for analysis by said first analyst.

19. A system for facilitating information storage and retrieval of addressing data, comprising:
an originating analyst center comprising a first server, said first server storing at least one legacy file containing addressing data;
a receiving analyst center comprising a web-enabled computer client system;
a host system including a second server in communication with said originating analyst center and said receiving analyst center via a communications network;
an addressing referral system executing on said second server, said addressing referral system including a graphical user interface;
a data repository in communication with said host system, said data repository storing addressing data imported and parsed from said at least one legacy file by said addressing referral system; and
at least one referral created by said originating analyst center via said graphical user interface, said at least one referral created in response to analysis performed on parsed addressing data; wherein said at least one referral is stored in said data repository and is accessible to said receiving analyst center;
wherein said at least one referral includes addressing data and a correction type code operable for recommending an action to be taken for said addressing data by said receiving analyst center.

20. The system of claim 19, further comprising:
a pending status assigned to said at least one referral indicating that said at least one referral requires further analysis at said receiving analyst center.

21. The system of claim 19, further comprising:
a status assigned to said at least one referral by said receiving analyst center in response to evaluating or performing said action for said addressing data, said status comprising at least one of:
a pending/referred status;
a closed status; and
a closed/no change status.

22. The system of claim 21, wherein said pending/referred status indicates that corrective action cannot be performed on addressing data in said at least one referral until additional information is obtained.

23. The system of claim 21, wherein said closed/no change status indicates that no action is required for addressing data in said at least one referral.

24. The system of claim 21, wherein said closed status indicates that corrective action has been successfully performed on addressing data in said at least one referral.

25. The system of claim 19, further comprising reports generated utilizing criteria selectable via said graphical user interface, said reports including:
a status report;
a history report;
an age by record report;
a report by duration; and
a report by correction type.

26. The system of claim 19, wherein said parsed addressing data includes at least one of:
a house number;
a unit number;
a floor number;
a building identifier;
a phone number;
a street name;
a community;
a district;
a state; and
an equipment identifier.

27. The system of claim 19, wherein said correction type code includes at least one of:
change address;
remove unit number;
remove building number;
remove facilities address;
change location standard;
add descriptive; and
change location data.

28. The system of claim 19, further comprising a priority assigned to said at least one referral, said priority operable for indicating an urgency for which performance of said action should be undertaken.

29. The system of claim 28, wherein said priority includes at least one of:
a multi-dwelling unit indicator which, if present on said at least one referral, indicates to said second analyst that an address subject to said at least one referral is associated with a group of related addresses and that said related addresses should be evaluated simultaneously with said address subject to said at least one referral; and
a dispatch status indicator which, if present on said at least one referral, indicates to said second analyst that a service order was recently corrected for an address subject to said at least one referral and that said second analyst should address issues presented in said at least one referral as high priority.

30. The system of claim 19, wherein said graphical user interface includes a filter tool operable for displaying only selected columns of parsed addressing data associated with referrals searched by one of said originating analyst center and said receiving analyst center;
wherein columns of parsed addressing data include:
a house number;
a unit number;
a floor number;
a building identifier;
a phone number;
a street name;
a community;
a district;
a state; and
an equipment identifier.
